(19) United States
(12) Patent Application Publication
(10) Pub. No.: US 2015/0247327 A1
(43) Pub. Date: Sep. 3, 2015

(54) PANELS AND TILES HAVING GEOMETRIC FEATURES

(71) Applicant: 3form, LLC, Salt Lake City, UT (US)

(72) Inventors: Guillaume Martin, Rochetoirin (FR); Michael Damen, Rochetoirin (FR)

(21) Appl. No.: 14/120,437

(22) Filed: Mar. 3, 2014

(51) Int. Cl. E04F 13/08; B44F 7/00; B44F 5/00

(52) U.S. Cl. CPC E04F 13/0862; B44F 5/00; B44F 7/00

(57) ABSTRACT

Implementations of the present invention include panels and/or sub-component tiles used to create the panels that employ a number of different shapes and designs. In one implementation, panels can be prepared from various full and half-sized tiles that have been cut to create the desired shape or design. A manufacturer can then assemble the tiles together to create a finished pane.

### CROSS-REFERENCE TO RELATED APPLICATIONS

N/A.

### BACKGROUND OF THE INVENTION

1. The Field of the Invention

This invention relates to architectural panels and tiles.

2. Background and Relevant Art

A number of disadvantages are present in the art of architectural design that can be addressed.

### BRIEF SUMMARY OF THE INVENTION

Implementations of the present invention include systems, methods, and apparatus related to architectural panels and tiles having unique design features. In one implementation, a manufacturer can assemble multiple tiles together to create a panel, or mix and match panels with tiles (or mix and match tiles) for certain design considerations. Implementations of the present invention can be made of any panel material, including natural or synthetic resin, glass, wood, or composites thereof.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIGS. 1A through 1G illustrate various facing and perspective views illustrating a panel having a “Braid” pattern;

FIG. 2A illustrates a perspective view of a panel having a “Jot” pattern;

FIGS. 3A through 3F illustrate various facing and perspective views of a panel having a “Dash” pattern;

FIGS. 4A through 4E illustrate various facing and perspective views of another panel having a “Dash” pattern;

FIGS. 5A through 5E illustrate various facing and perspective views of another panel having a “Dash” pattern;

FIGS. 6A through 6I illustrate various facing and perspective views of another panel having a “Ray” pattern;

FIGS. 7A illustrates a perspective view of panel planks having a “Ray” pattern;

FIGS. 8A through 8C illustrate various facing and perspective views of another panel having a “Ray” pattern;

FIGS. 9A through 9G illustrate various facing and perspective views of a panel having a “Burst” pattern;

FIG. 10A illustrates a perspective view of a panel having a “Zing” pattern;

FIGS. 11A through 11M illustrate various facing and perspective views of a tile having a “Swoon” pattern; and

FIG. 12A illustrates a perspective view of a tile having a “Flank” pattern.

### DETAILED DESCRIPTION OF THE PREFERRED EMBODIMENTS

Implementations of the present invention solve one or more problems in the art with systems, components, and apparatus that enable a manufacturer, or designer to create unique panel designs. In one implementation, the panels can be created from one or more sub-component tiles that are assembled along a common bevel/edge. One will appreciate that the panels and corresponding panel designs of the present invention can be assembled from any number of materials that can be formed into the shapes and designs disclosed and claimed herein, and such materials can include but are not limited to resins (e.g., polyesters, copolyesters, polycarbonate, acrylic), glass, wood, medium-density fiberboard (MDF), and composites thereof, all of the foregoing in any naturally-occurring or synthetic forms.

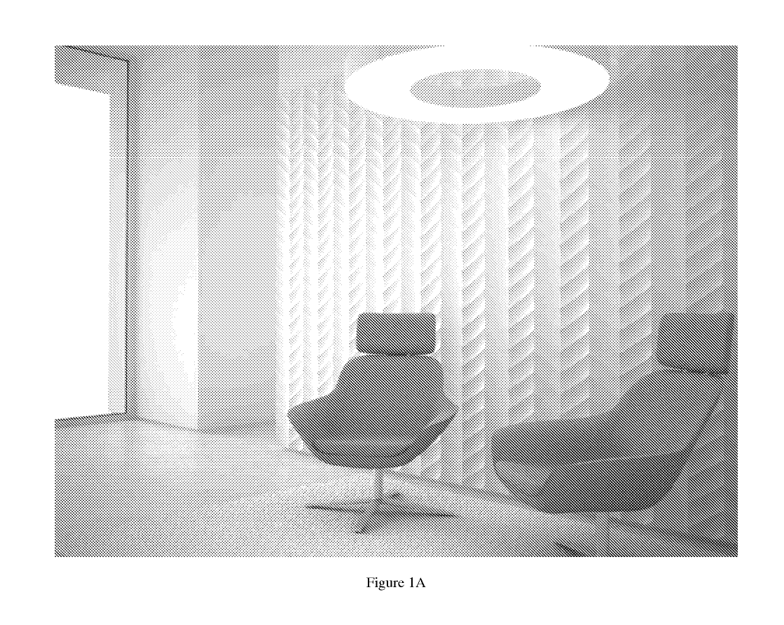

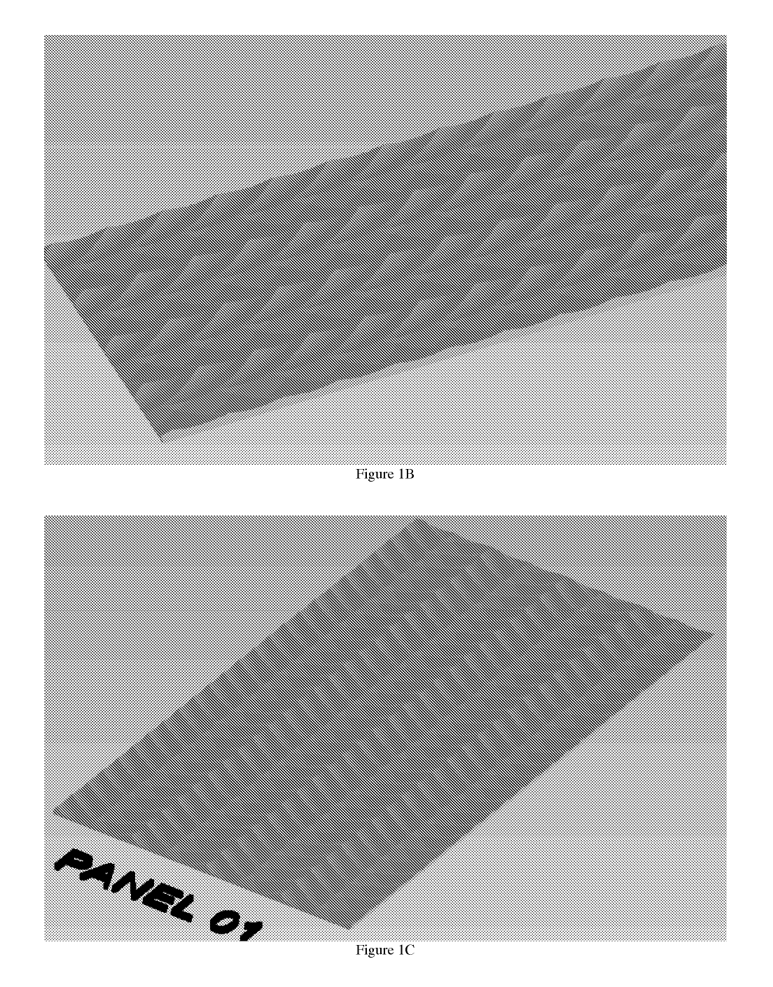

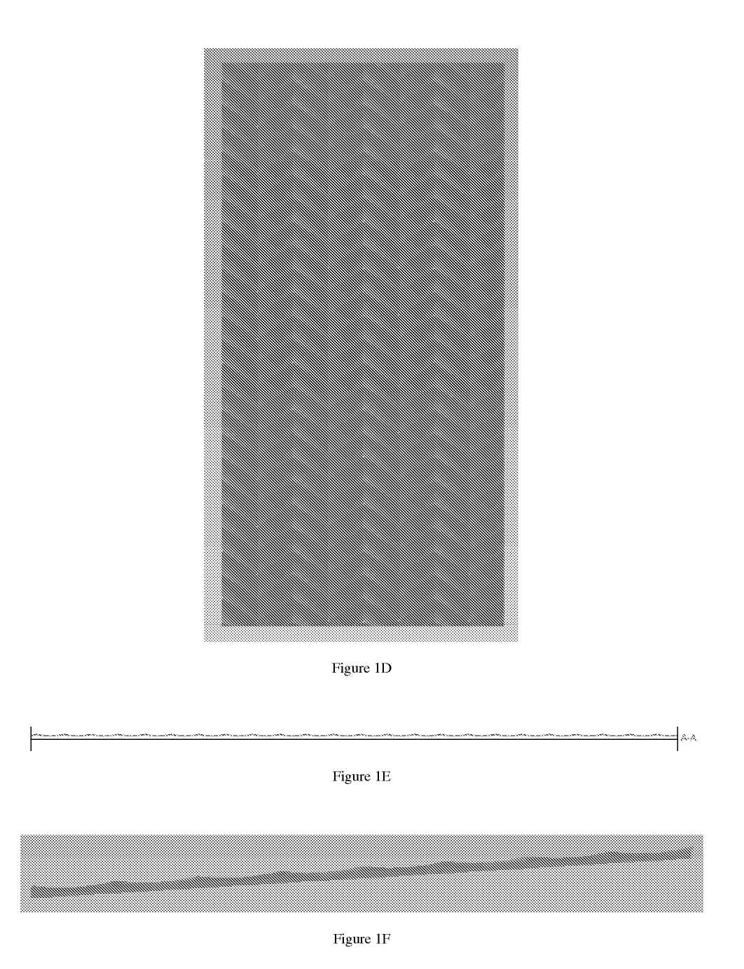

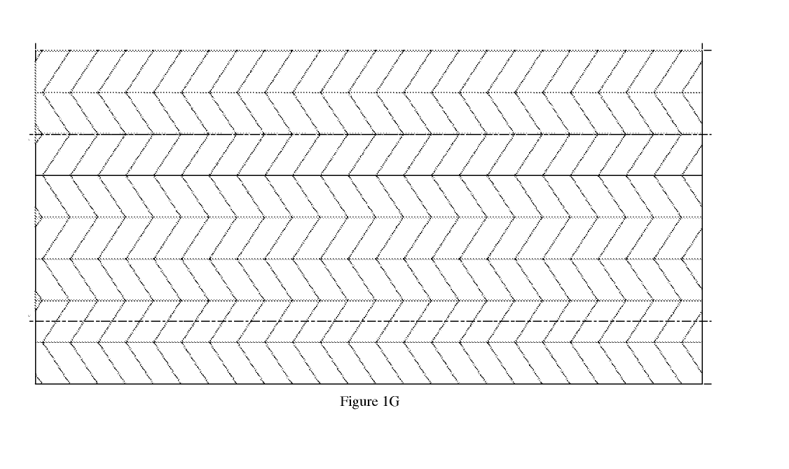

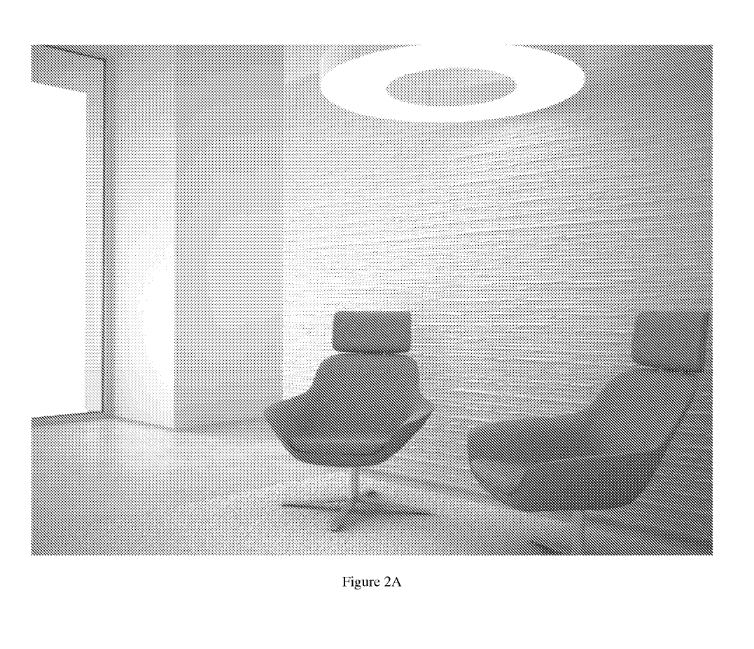

FIGS. 1A through 1G illustrate various facing and perspective views illustrating a panel having a “Braid” pattern. FIG. 1A is a photograph of panels with the Braid pattern in assembled form, while FIGS. 1A-1F are various facing, side, or perspective views prepared in a computer-aided design (CAD) modeling program. FIG. 1G is a line drawing of the panel at a facing view.

FIG. 2A illustrates a perspective view of a panel having a “Jot” pattern. FIG. 2A, in particular, is a photograph of panels having the Jot pattern.

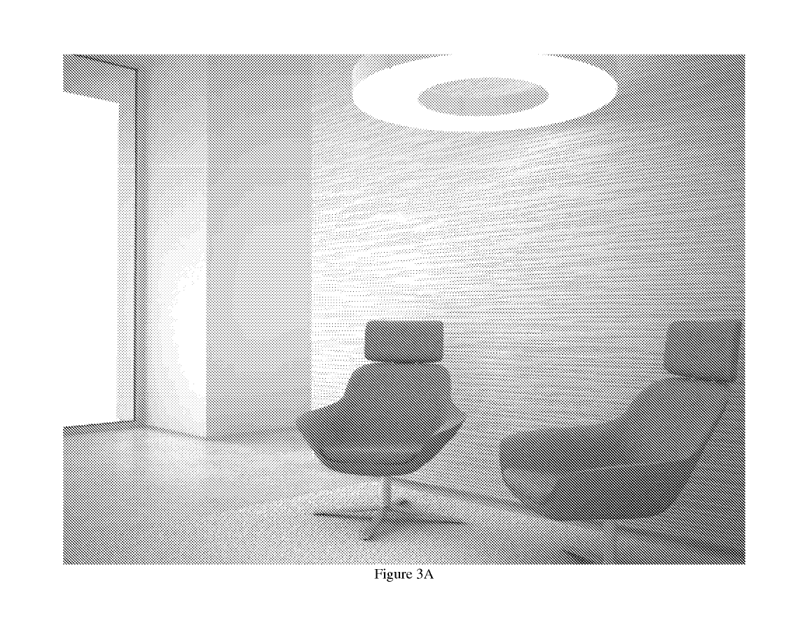

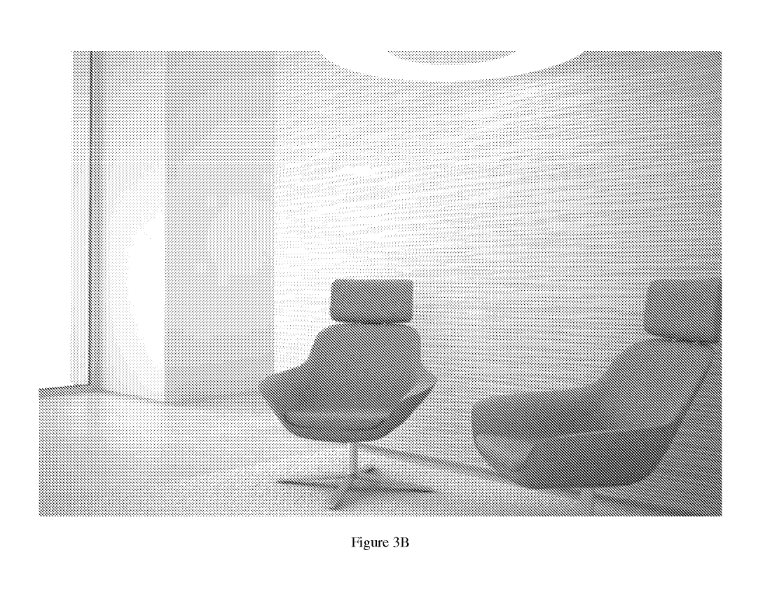

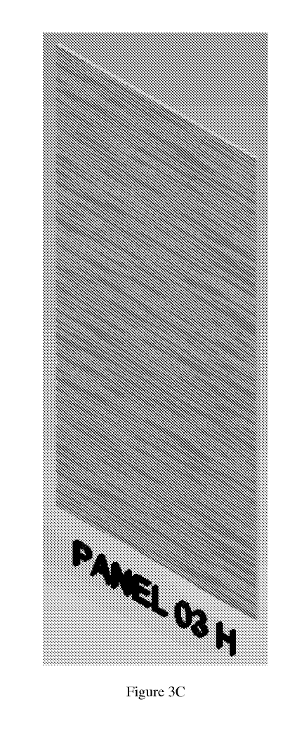

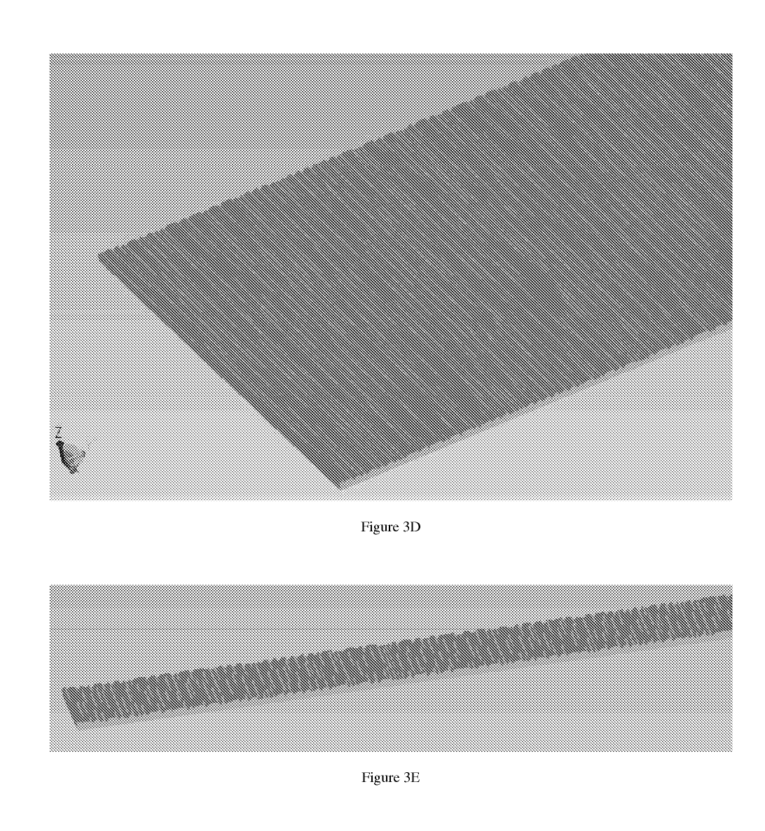

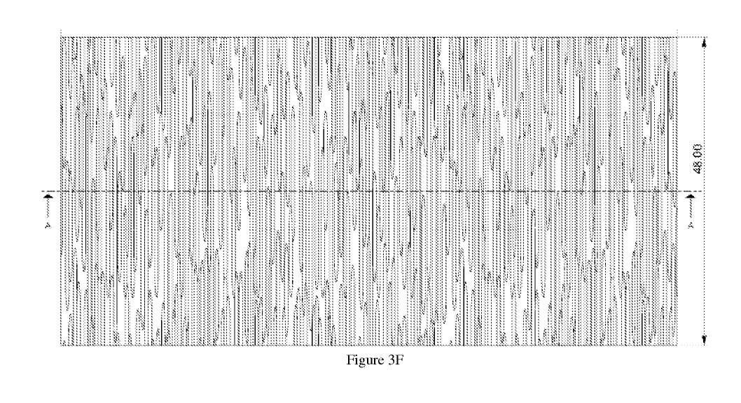

FIGS. 3A through 3F illustrate various facing and perspective views of a panel having a “Dash” pattern. FIGS. 3A and 3B, in particular, are photographs of panels having the Dash pattern in assembled from. FIGS. 3C-3E are various facing, side, or perspective views prepared in a computer-aided design (CAD) modeling program. FIG. 3F is a line drawing of the panel at a facing view.

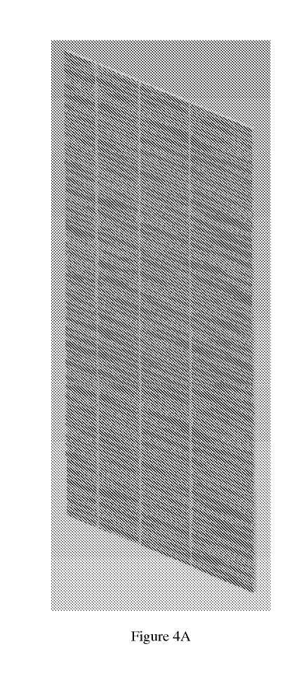

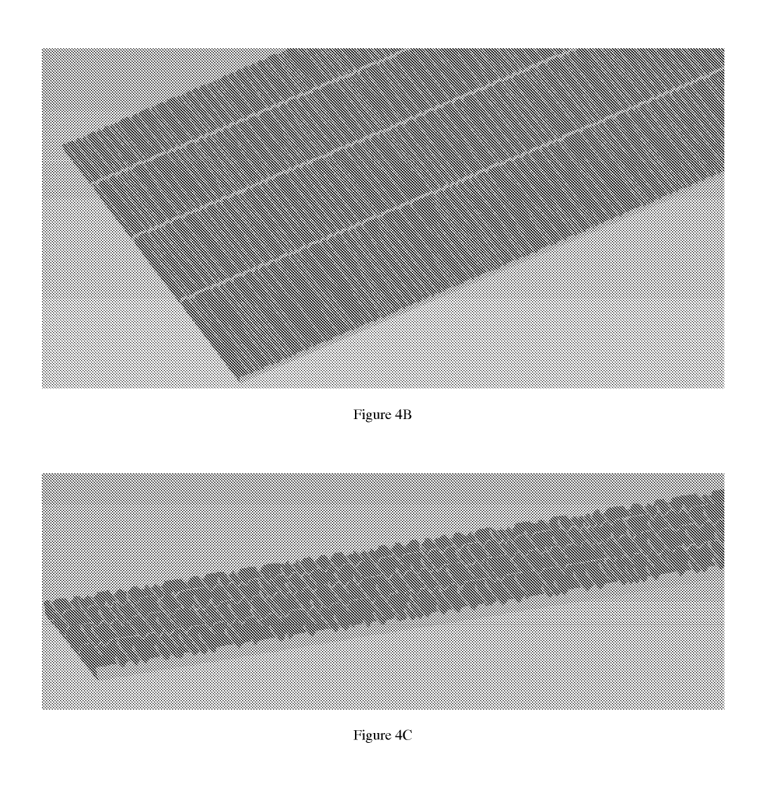

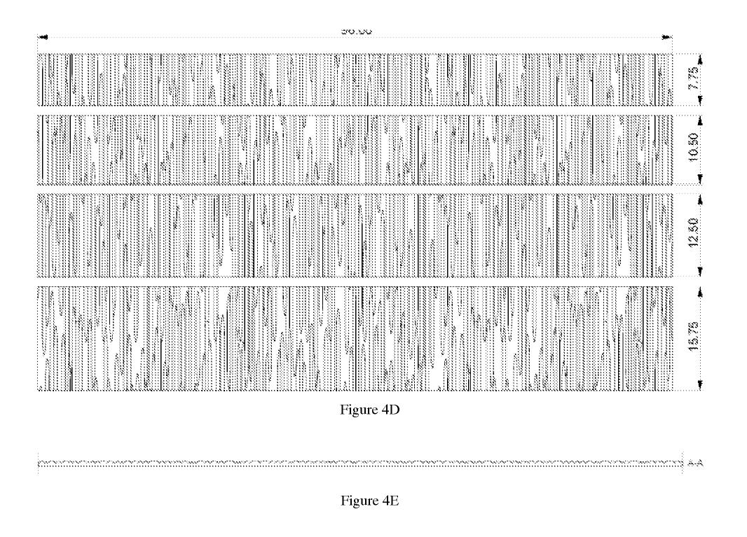

FIGS. 4A through 4E illustrate various facing and perspective views of another panel having a “Dash” pattern. FIGS. 4A through 4C, in particular, are various facing, side, or perspective views prepared in a computer-aided design (CAD) modeling program. FIGS. 4D and 4E are line drawings of the panel at facing and side views.

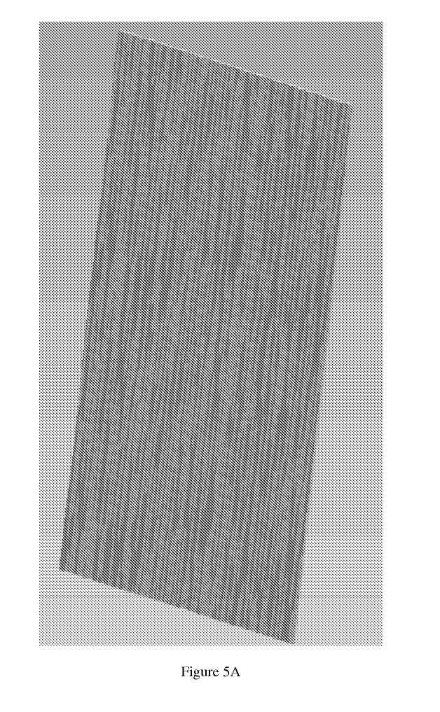

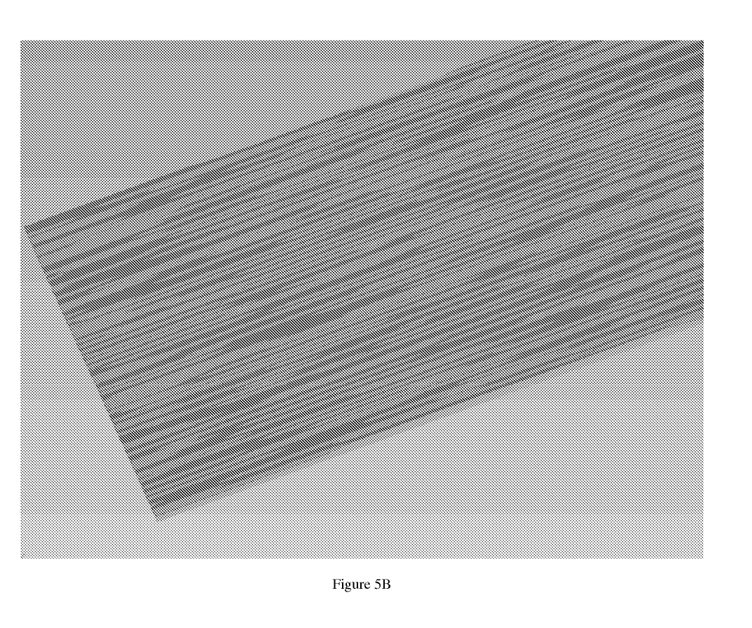

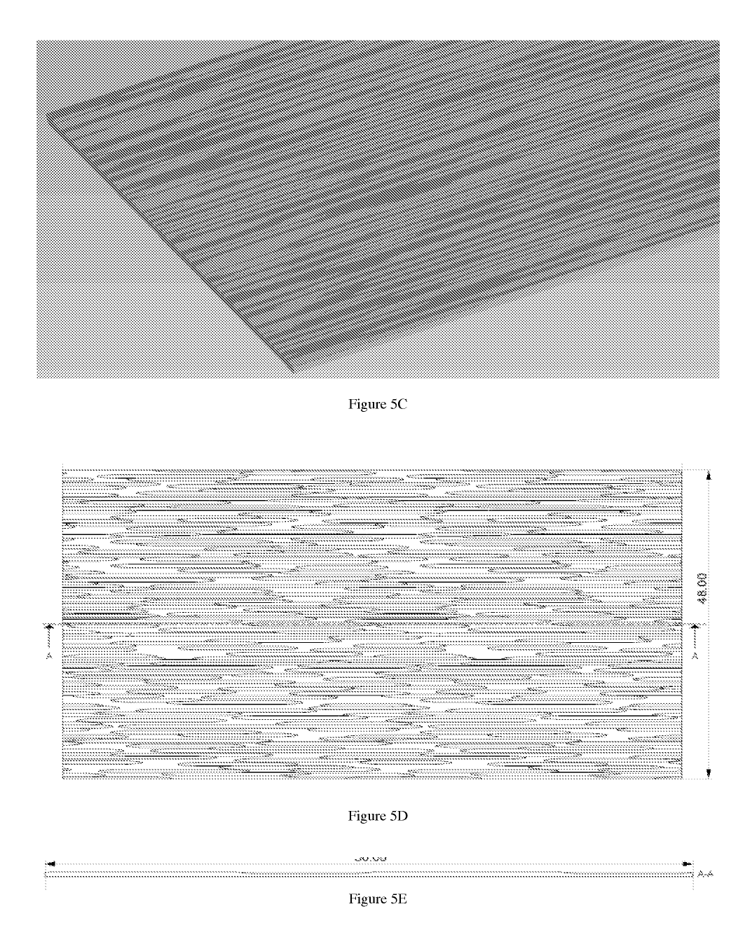

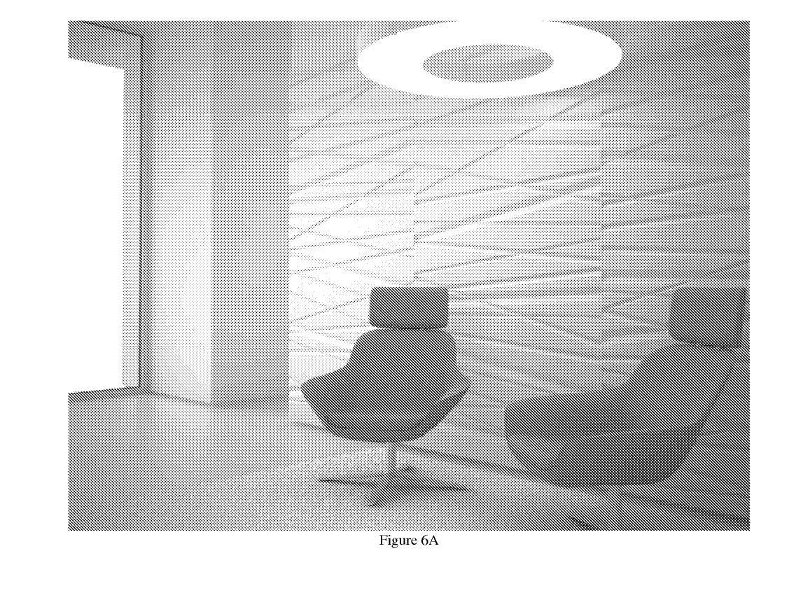

FIGS. 5A through 5E illustrate various facing and perspective views of another panel having a “Dash” pattern. FIGS. 5A through 5C, in particular, are various facing, side, or perspective views prepared in a computer-aided design (CAD) modeling program. FIGS. 5D and 5E are line drawings of the panel at facing and side views.

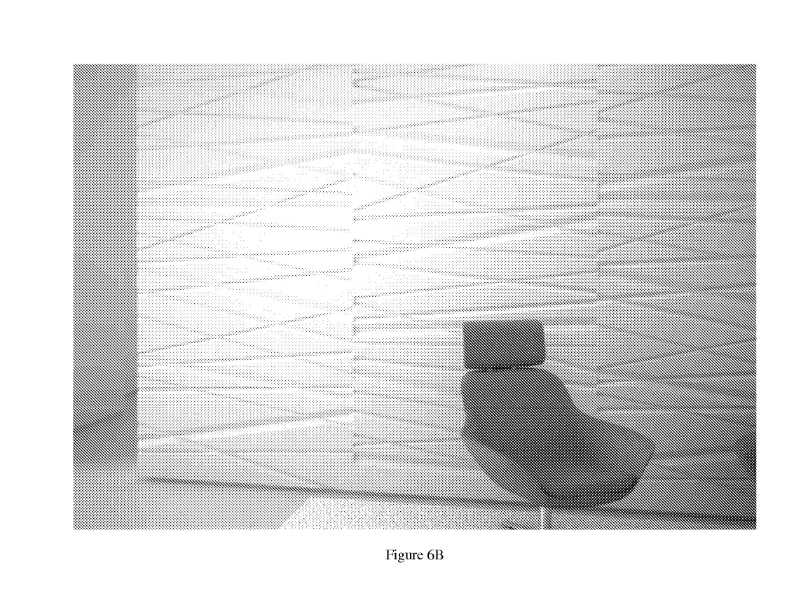

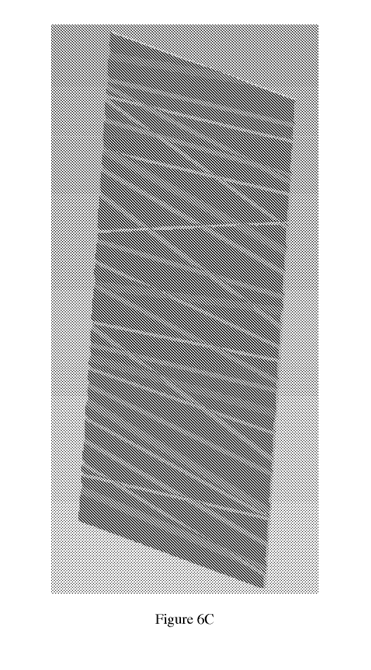

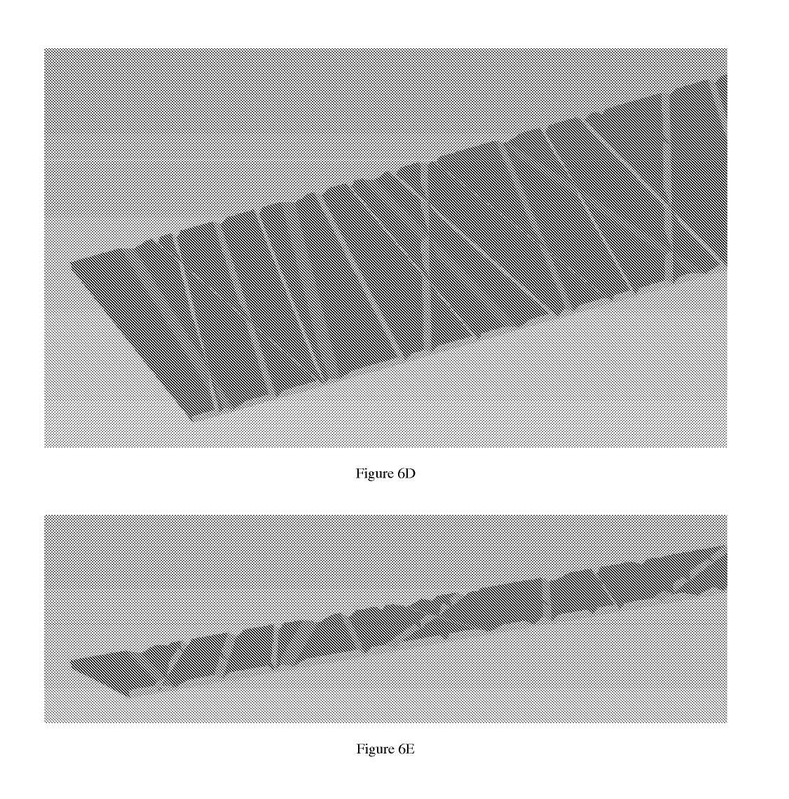

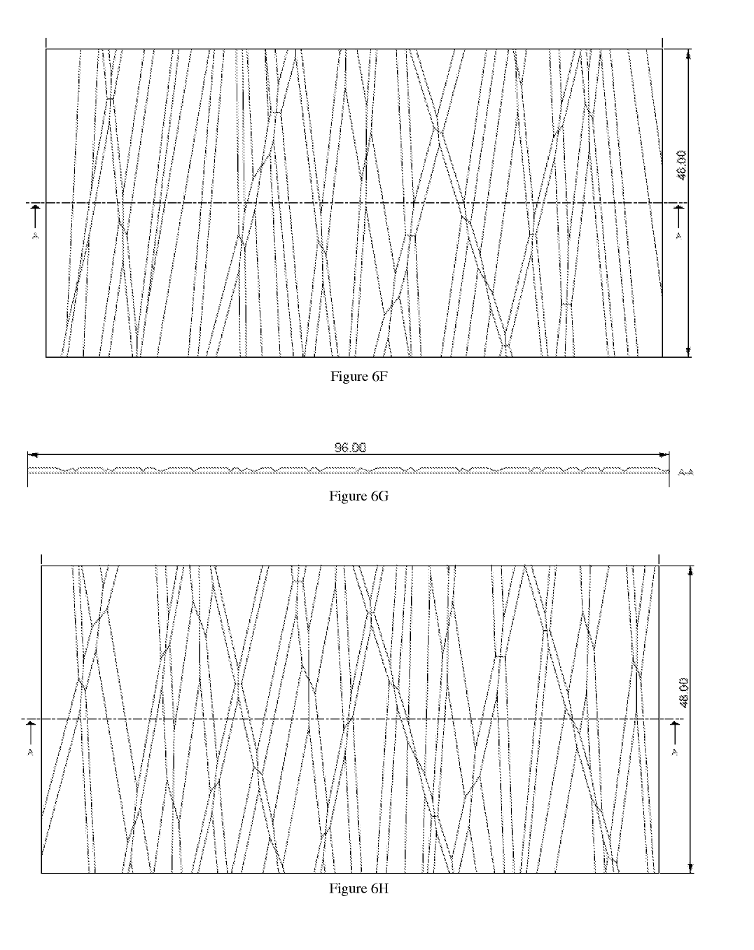

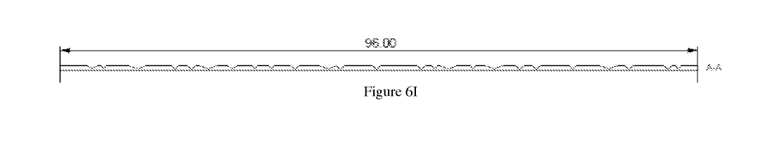

FIGS. 6A through 6I illustrate various facing and perspective views of another panel having a “Ray” pattern. FIGS. 6A and 6B are photographs of panels with the Ray pattern in assembled form. FIGS. 6C-6E are various facing, side, or perspective views prepared in a computer-aided design (CAD) modeling program. FIGS. 6F-6I are line drawings of the panel at facing and side views.

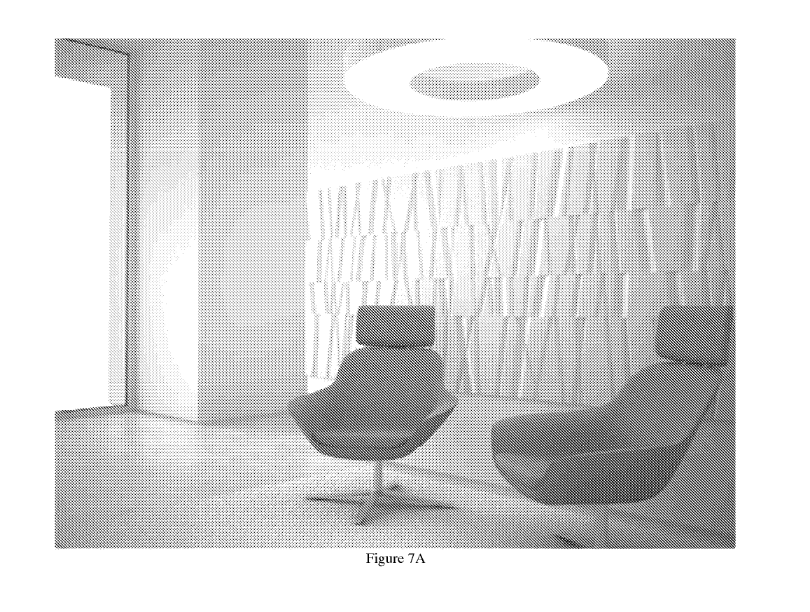

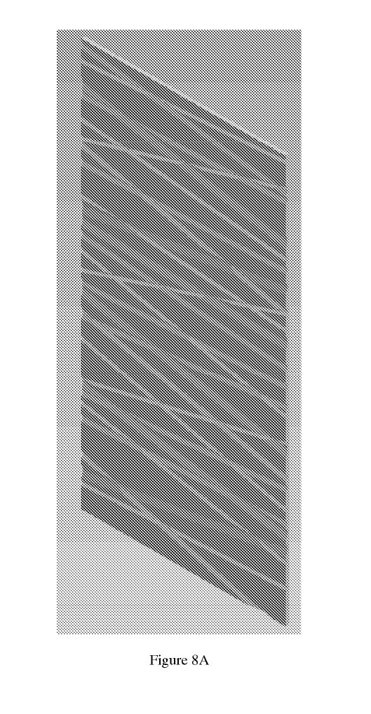

FIG. 7A illustrates a perspective view of panel planks having a “Ray” pattern. FIG. 7A, in particular, is a photograph of panels having the Ray pattern.

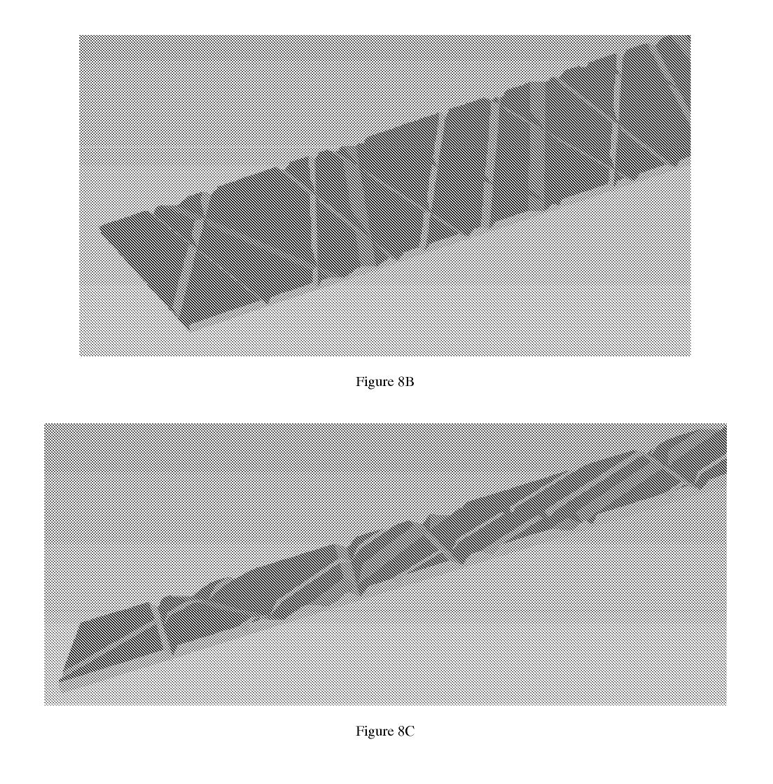

FIGS. 8A through 8C illustrate various facing and perspective views of another panel having a “Ray” pattern. In particular, FIGS. 8A-8C are various facing, side, or perspective views prepared in a computer-aided design (CAD) modeling program.

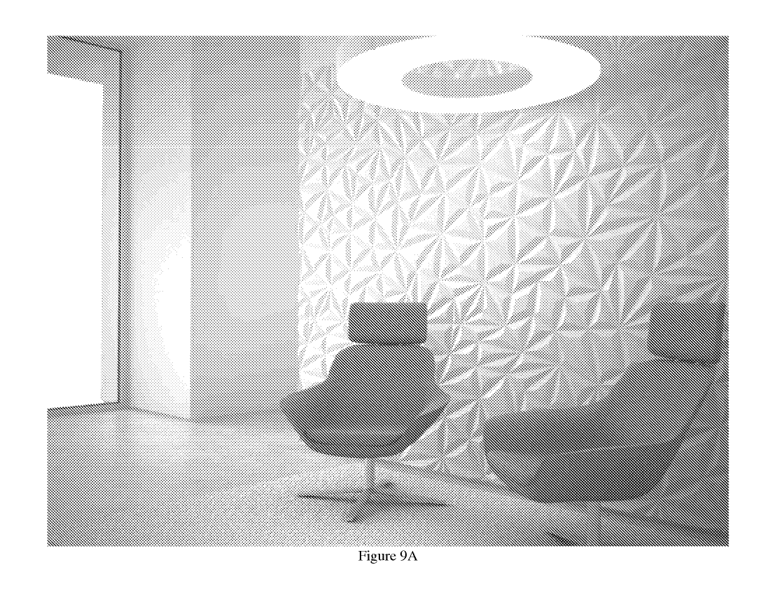

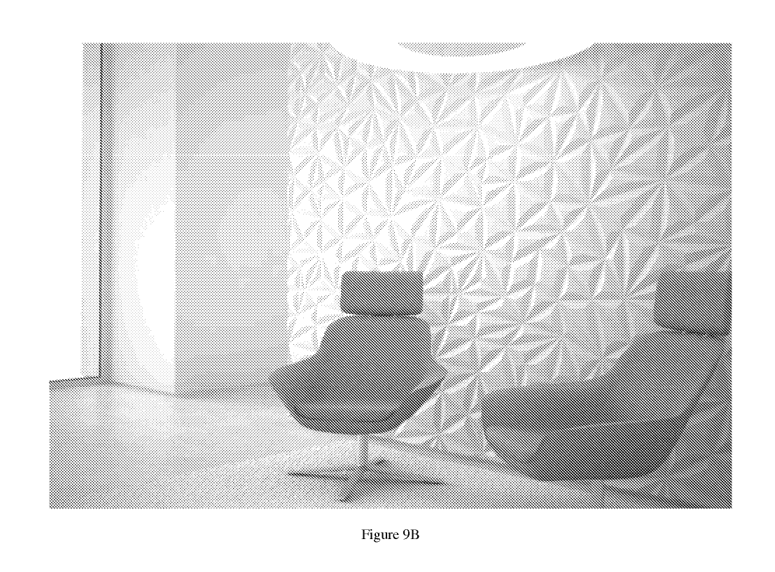

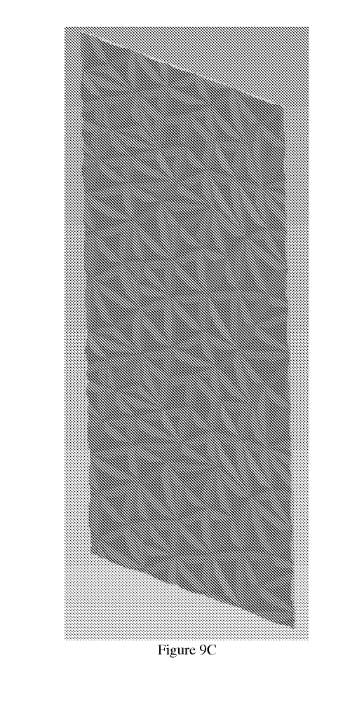

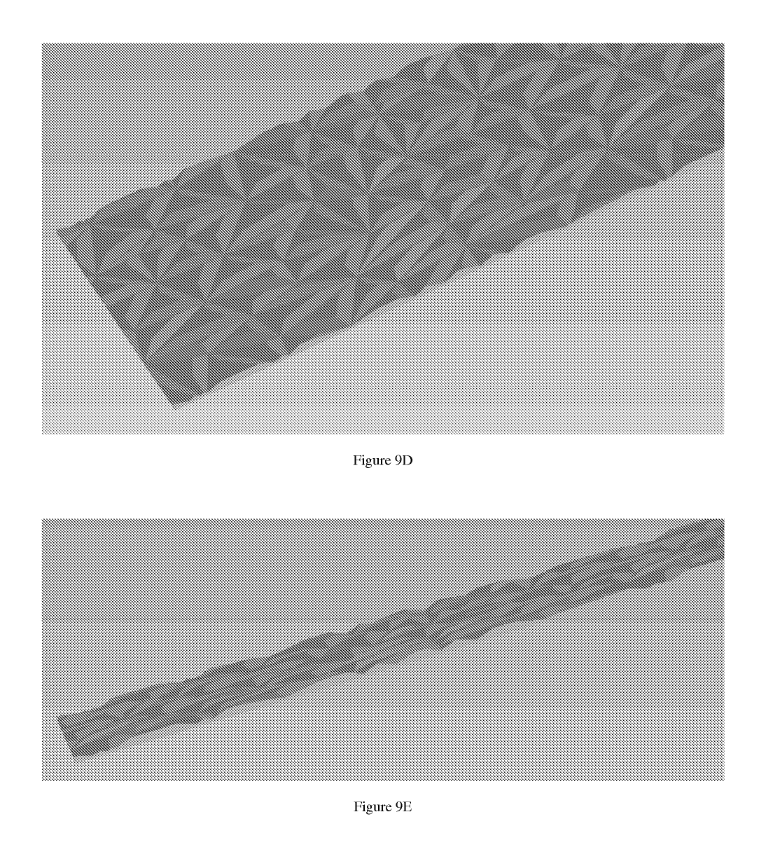

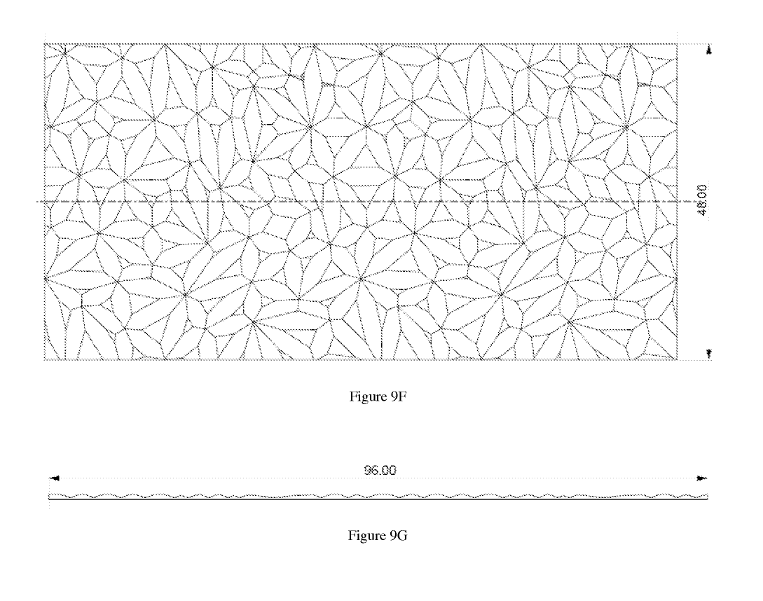

FIGS. 9A through 9G illustrate various facing and perspective views of a panel having a “Burst” pattern. FIGS. 9A and 9B are photographs of panels with the Burst pattern in assembled form. FIGS. 9C-9E are various facing, side, or perspective views prepared in a computer-aided design (CAD) modeling program. FIGS. 9F-9G are line drawings of the panel at facing and side views.

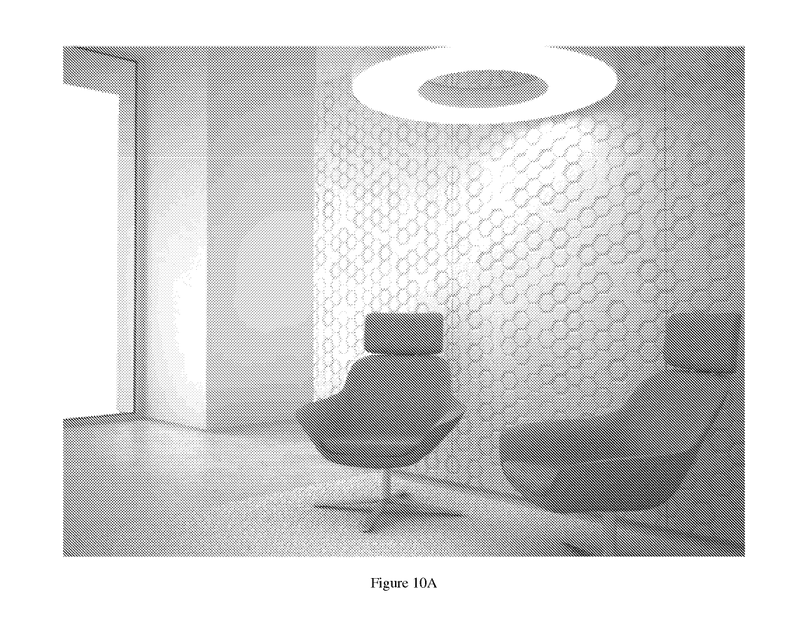

FIG. 10A illustrates a perspective view of a panel having a “Zing” pattern. FIG. 10A, in particular, is a photograph of panels having the Zing pattern.

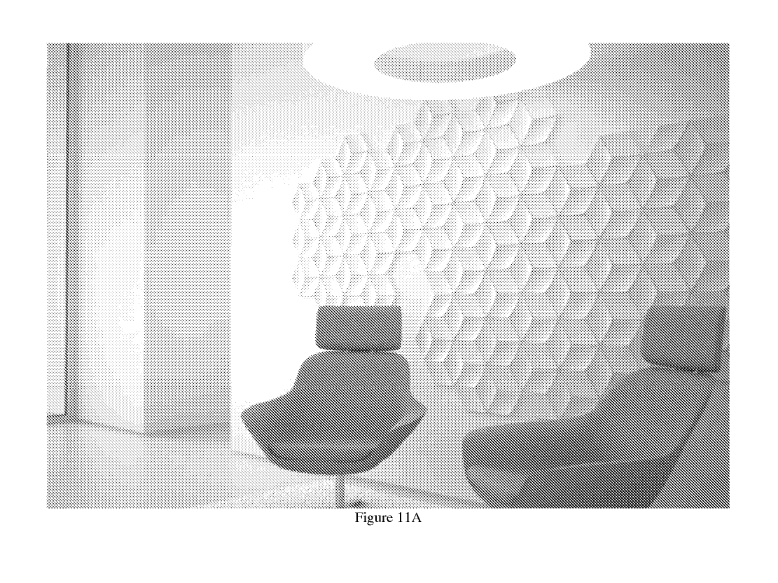

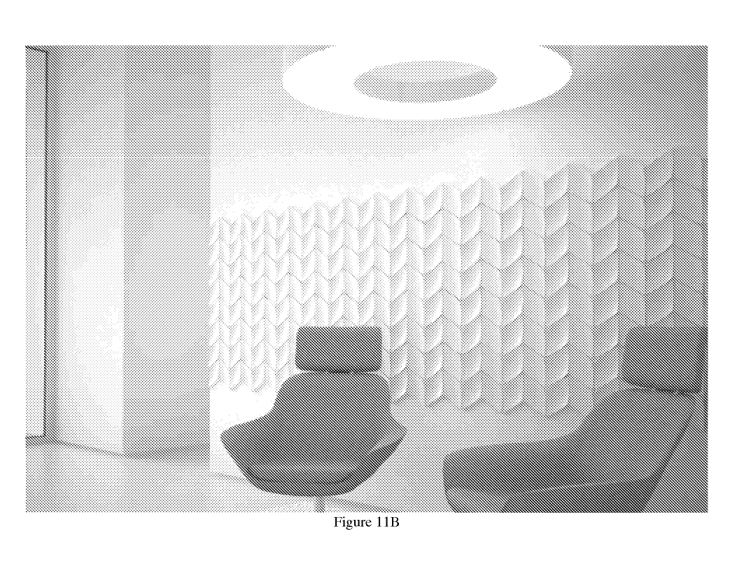

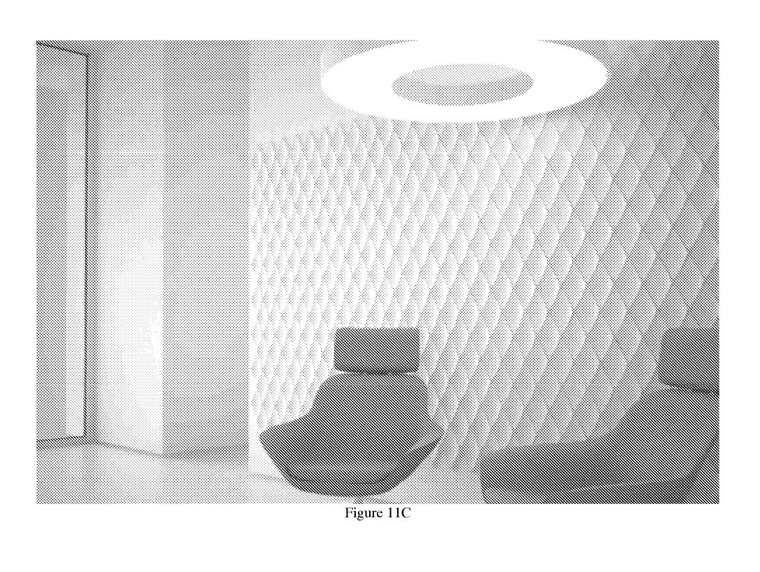

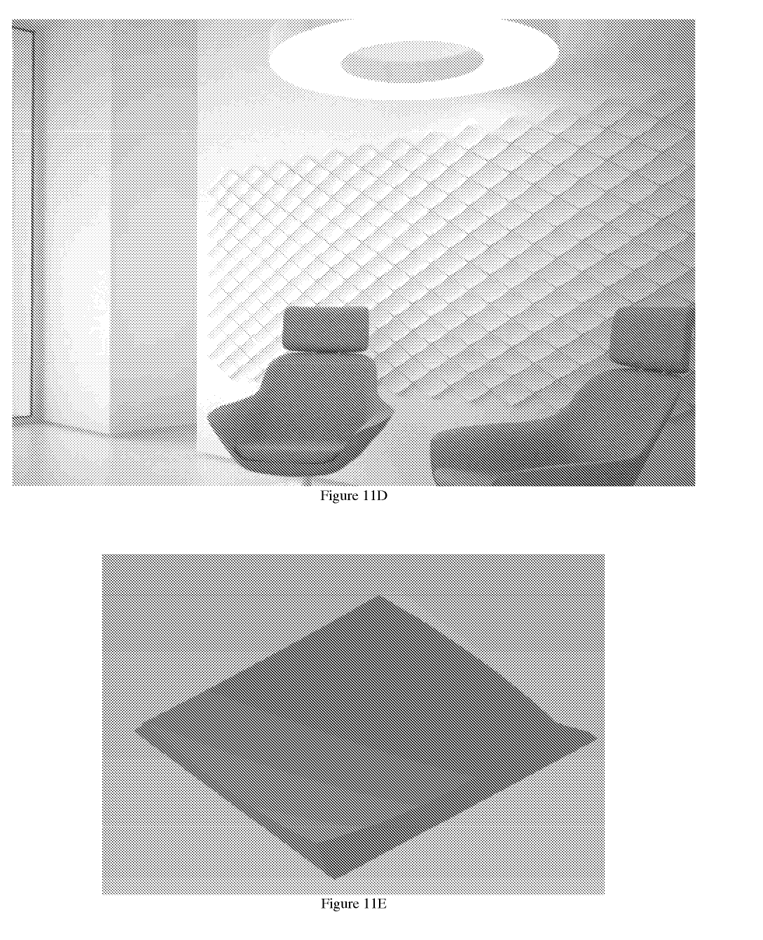

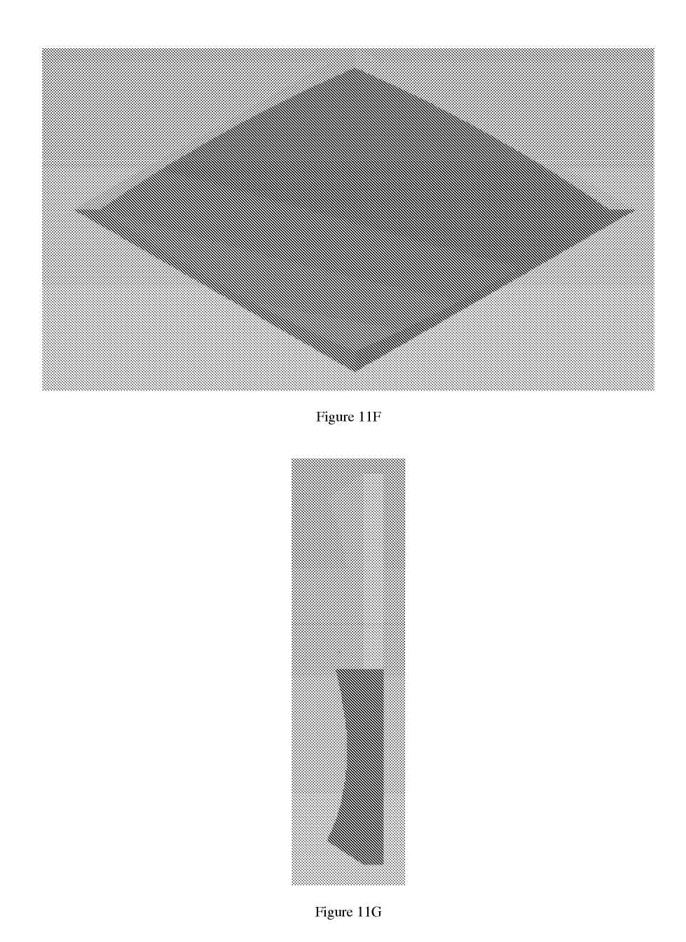

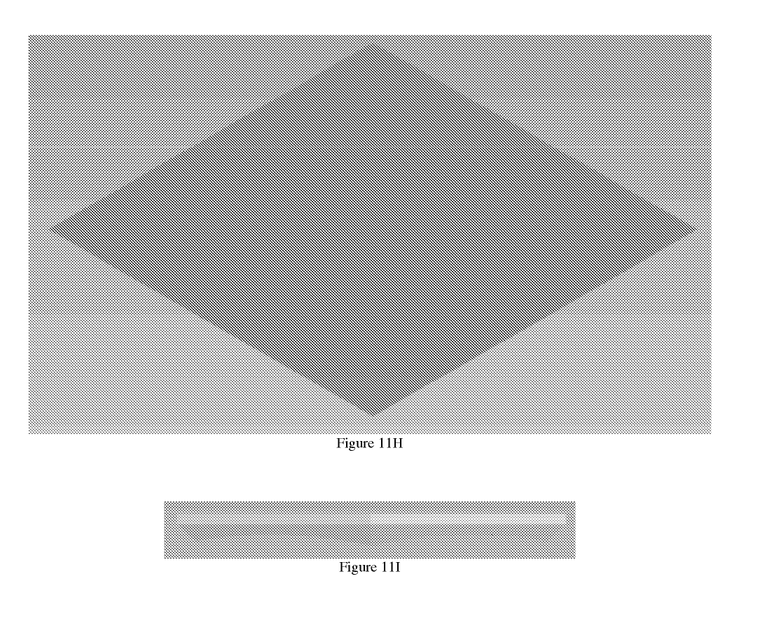

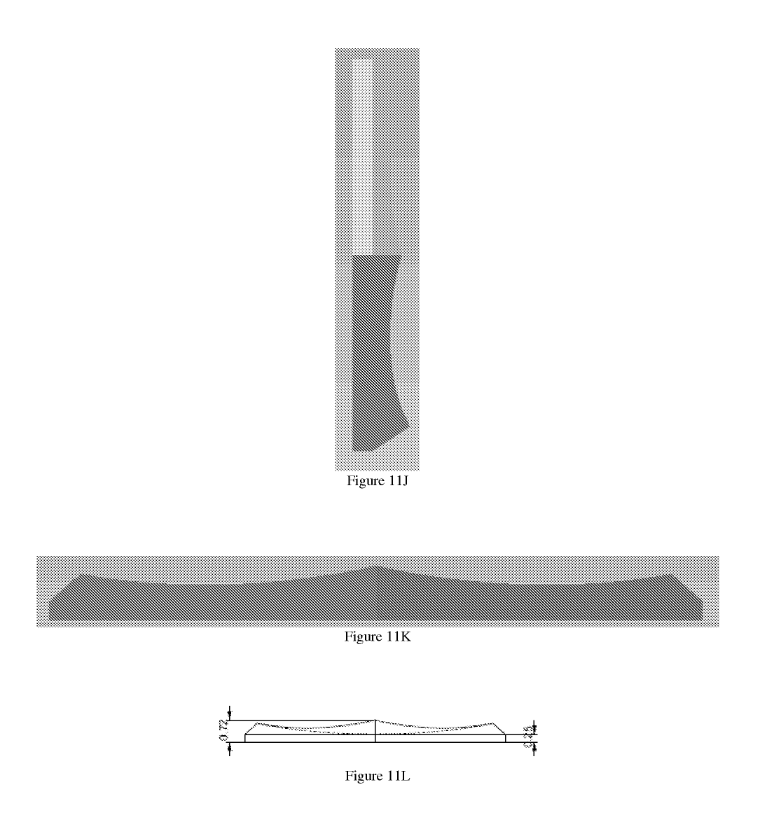

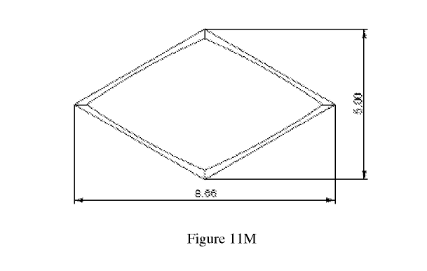

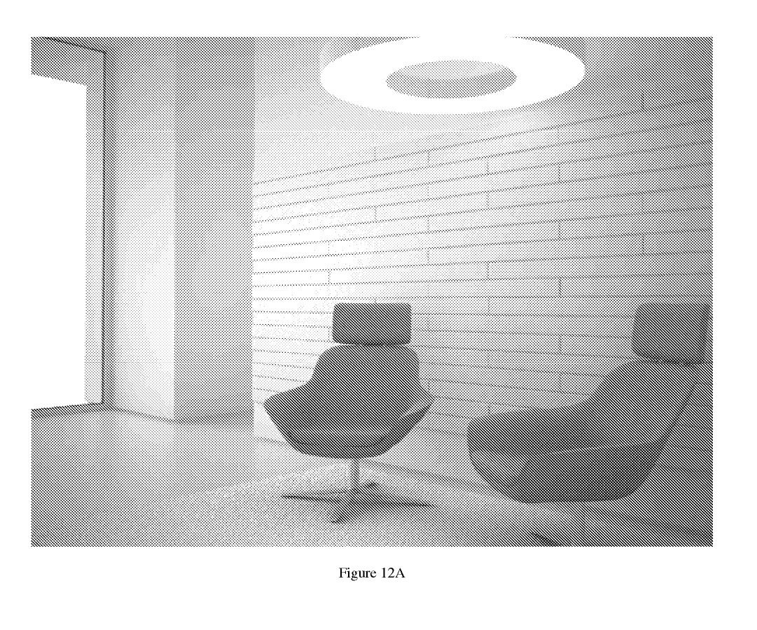

FIGS. 11A through 11M illustrate various facing and perspective views of a tile having a “Swoon” pattern. FIGS. 11A and 11D are photographs of panels with the Swoon pattern in assembled form. FIGS. 11E-11K are various facing, side, or perspective views prepared in a computer-aided design (CAD) modeling program. FIGS. 11I-11M are line drawings of the panel at facing and side views.

FIG. 12A illustrates a perspective view of a tile having a “Flank” pattern. FIG. 12A, in particular, is a photograph of panels having the Flank pattern.

One will appreciate that each contour, shape, and dimension of the patterns of the panels and tiles disclosed herein are readily understood from the drawings, or can be readily deduced therefrom. One will further appreciate that the patterns, and dimensions of the panels disclosed herein can provide a number of aesthetic and functional advantages in the art.

In at least one implementation, a manufacturer can implement a system in which the manufacturer interchanges various panels or tiles of different patterns, or panels or tiles of different materials, colors, or configurations, for added effect.

In at least one implementation, a manufacturer prepares the panels or tiles shown herein through any number of mechanisms, including but not limited to processing various panel materials through a milling machine, such as a computer numerical control (CNC) machine. The manufacturer can use the machine not only to cut the panels or tiles to appropriate size, but also to ensure that the edges and beveling enable a substantially flush alignment with other panels or tiles. Once cut to the appropriate size, design, and dimension, the assembler can then place the panels or tiles in substantially flush configuration together against a surface, such as a wall, ceiling, or floor. In at least one implementation, the assembler uses one or more adhesives to adhere or otherwise affix the panels or tiles to the surface. Other methods and mechanisms for affixing the panels or tiles in position are possible within the scope of the invention. Such other methods and mechanisms can further include the use of fasteners or the like.

The present invention thus may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

I claim:

1. A panel having a Braid design, as shown in the Figures, and a process of making or assembling the same.

2. A panel having a Jot design, as shown in the Figures, and a process of making or assembling the same.

3. A panel having a Dash design, as shown in the Figures, and a process of making or assembling the same.

4. A panel having a Ray design, as shown in the Figures, and a process of making or assembling the same.

5. A panel having a Burst design, as shown in the Figures, and a process of making or assembling the same.

6. A panel having a Zing design, as shown in the Figures, and a process of making or assembling the same.

7. A panel, or a set of one or more tiles, configured with a Swoon design as shown in the Figures, and a process of making or assembling the same.

8. A panel, or a set of one or more tiles, configured with a Flank design as shown in the Figures, and a process of making or assembling the same.
